(19) United States
(12) Patent Application Publication
(10) Pub. No.: US 2006/0099334 A1
(43) Pub. Date: May 11, 2006

(54) Apparatus and method for applying a coating to a windshield

(76) Inventors: Joseph O'Brien, Detroit, MI (US); Duane Dudas, White Lake, MI (US); Michele Zinger, Oxford, MI (US)

Correspondence Address: Thomas D. Helmholdt;Young & Basile, P.C., Suite 624, 3001 West Big Beaver Road, Troy, MI, 48084, US

(21) Appl. No.: 10/983,948

(22) Filed: Nov. 8, 2004

(51) Int. Cl. C03C 17/00; G01N 21/55; G01N 21/84

(52) U.S. Cl. 427/163.1; 427/402; 118/256; 118/683

(57) ABSTRACT

An apparatus and process for applying a material layer to a workpiece for a vehicle can include ultrasonically verifying a residual film from a first material layer previously applied to a surface of a workpiece, and verified, applying a second material layer over the first material layer on the surface of the workpiece. The first material layer can include a pre-primer material. The pre-primer material layer can be dried to form a clear transparent surface. The second material layer can include a primer material for application to the pre-primer material layer previously applied to the surface of the workpiece to be treated. A urethane sealant material can then be applied to the primer material layer previously applied to the surface of the workpiece. The workpiece can include a contour class member for a vehicle, such as a front window, rear window, or side window, and/or roof window.

### FIELD OF THE INVENTION

The present invention is directed to a verification and coating apparatus and method for applying a material to a workpiece, and more particularly to a verification and coating apparatus and method for applying a primer coating to a ultrasonically verified clear pre-primer coating on an edge of a windshield, lights, and/or back window.

### BACKGROUND

Insulation of fixed windows in automotive vehicles previously required manual installation of a glazing unit using suitable mechanical fasteners, such as metal clips, for securing the glazing unit with respect to the vehicle body. Sealant typically was applied around the marginal edges of the glazing unit, prior to positioning decorative strips around the glazing unit to conceal the interface between the marginal edges of the glazing unit and the adjacent portions of the vehicle body. Manual assembly and installation of glazing units was inefficient, expensive, and not amenable to accommodate increased automotive production on an automated automobile assembly line.

Unitary window assemblies were later developed to provide a sheet of glass with an adjacent peripheral frame. A gasket of molded material extended between the frame and the peripheral margin of the window to hold the glass sheet within the frame. Fasteners were provided at spaced locations along the frame to permit the entire assembly to be guided into position over an appropriate opening in a vehicle and to secure the entire assembly to the vehicle as a unit. While this window structure reduced the assembly time and simplified installation of the window unit in a vehicle opening, the labor required to manually assemble the frame and gasket with respect to the glass resulted in a relatively high cost per unit.

Individual sheets of glass or laminated glass units have been formed with integral frame or gasket members molded and cured in situ by injection molding. These configurations seek to eliminate the manual assembly of the unit. The assembly has been referred to as an encapsulated glazing unit. The encapsulated glazing units require a minimum of manual labor for assembly and can be readily attached to openings through the vehicle body during assembly on an automated production line. A predetermined portion of the marginal periphery of a sheet of transparent material is disposed within a mold structure during fabrication of the encapsulated glazing unit. A polymeric gasket forming material is injected into the mold cavity and cured in situ on the sheet to encapsulate the marginal peripheral edge portion of the sheet. The resulting assembly is readily attachable to a periphery defining a window opening through a vehicle body during manufacturer and assembly of the vehicle.

It is known to be difficult to form a gasket material having a permanent, long term bond directly to a glass surface. The gasket materials can fail to maintain adhesion to the glass surface for a sufficient length of time to be consistent with the life of the vehicle. Exposure to environmental conditions can cause gasket material to loosen from the glass surface over time, and ultimately may separate entirely from the glass surface. It is known to apply a coating of a liquid primer material to the effected surface of the glass prior to formation of a gasket thereon in order to improve the adherence of a gasket material to the glass surface and to increase the expected life of the encapsulated glazing unit. A band of the primer material along the appropriate edge portion of the glass panel can be applied manually or through automated processing equipment. The primer layer, typically a urethane material, is best applied as a uniform, continuous, relatively thin band in order to function properly. The primer layer may separate within an excessively thick layer along a cleavage plane resulting in failure of the bond. The primer layer may be ineffective for its intended purpose if not of sufficient thickness or of certain areas are not coated.

A programed robot or other motion device can be used to define a path of travel coinciding with a perimeter or other path associated with a product to be coated. Applications can involve depositing primer material, paint material, activator material, adhesive material, or the like to aid in the attachment of foam tapes, plastic moldings, metal components, such as hinges, locks, and all types of encapsulated products.

Prior to the application of certain primer materials, it is known to be advantageous to provide a pre-primer coating or surface treatment of a glass surface in order to better adhere the primer coating to the glass surface. Certain pre-primer coatings for glass surfaces clean or etch the glass surface in preparation for the application of the primer coating. The pre-primer coating or surface treatment can dry to a clear, transparent, virtually invisible, surface. In such applications, it is difficult to visually verify proper application of the pre-primer coating prior to application of the primer coating to the glass surface. Failure to properly pre-prime the glass surface can result in failure or unsatisfactory performance of the primer coating in performing its intended function. It would be desirable to provide an apparatus and method for verification of the presence and proper application of the pre-primer material prior to the application of the primer material layer.

### SUMMARY

The verification and coating apparatus and method according to the present invention will generally be described with regard to a particular automotive application, since one of the primary applications of the verification and coating apparatus and method is the automotive glass industry where a material applicator is used to apply various fluids to an edge of a windshield, side light, and/or a backlight glass. However, it should be understood that the present invention is also suitable for a wide range of other material applying applications. The automotive glass application description is therefore by way of example and not limitation with respect to the possible applications of the present invention. The present invention is particularly adapted for the production of glazing units or window assemblies for automotive vehicles, although it will find utility generally in other material application fields as well.

The present invention provides an apparatus and process for applying a material layer to a workpiece for a vehicle. By way of example and not limitation, a contoured glass workpiece can have a pre-primer material layer applied along a predetermined path on a surface of the workpiece leaving a residual film. An ultrasonic sensor can be provided for identifying a workpiece configuration, and for verifying presence of the residual film of pre-primer material layer along the predetermined path on the surface of the workpiece. A first applicator can be provided for applying a primer material layer over the pre-primer material layer on a surface of the workpiece, if presence of the residual film is verified by the ultrasonic sensor. A second applicator can be provided for applying a urethane sealant material layer over the primer material layer on the surface of the workpiece.

A process according to the present invention can be used for applying a layer of material to a workpiece for a vehicle. By way of example and not limitation, the process according to the present invention can include the steps of ultrasonically verifying a residual film from a first material layer previously applied to a surface of a workpiece, and if verified, applying a second material layer over the first material layer on the surface of the workpiece. The first material layer can include a pre-primer material layer covering at least a portion of the surface of the workpiece along a predetermined path. The second material layer can include a primer material applied over the first material layer on the surface of the workpiece. A third material layer can be provided for application over the second material layer on the surface of the workpiece. By way of example and not limitation, the third material layer can be a urethane sealant material for connecting and sealing a contoured glass workpiece to an opening in a vehicle body. If the residual film from the first material layer is not verified, the workpiece can be rejected as being defective prior to further processing.

According to the present invention, the apparatus and process encompass different workstation configurations providing various degrees of processing flexibility and production throughput. The apparatus and process according to the present invention can also identify at least one of a pattern, size, and shape of a workpiece to be processed, and based on the identification can select material layers to be applied, in sequence of application of the material layers, and a path of applicator travel.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a simplified schematic plan view of a black prime application to heated glass projected to be capable of processing 20 jobs per hour;

FIG. 2 is a simplified schematic plan view of a red and black prime application workstation projected to be capable of processing 65 jobs per hour;

FIG. 3 is a simplified schematic plan view of a red and black prime application workstation projected to be capable of processing 130 jobs per hour; and

FIG. 4 is a simplified flow diagram illustrating various process steps according to one example of the present invention.

### DETAILED DESCRIPTION OF THE PREFERRED EMBODIMENT

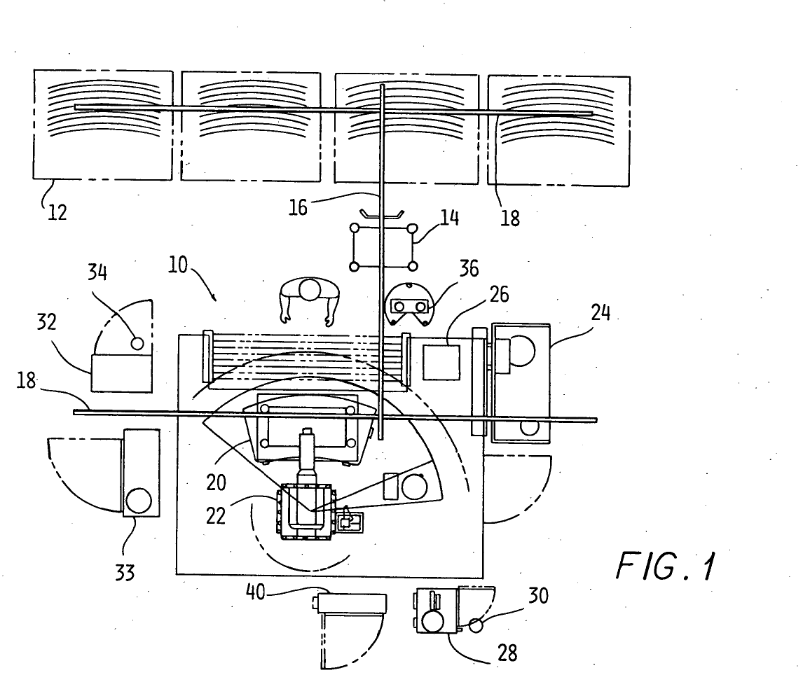

Referring now to FIG. 1, a workstation 10 is illustrated including a plurality of glass workpiece racks 12. At least one workpiece rack 12 can be provided for workpieces to be processed, while at least one rack 12 can be provided for workpieces that have been processed. An operator load assist fixture 14 can be provided with a bridge 16 and rails 18. The load assist fixture 14 can include 90 degrees of motion (horizontal to vertical). Hand controls can be provided for manual or automated motion of the fixture. Vacuum cups and control circuitry can be provided connected to a source of vacuum for selectively engaging and disengaging a workpiece to be loaded and/or unloaded from the storage rack 12 for delivery to and from a glass nesting fixture 20. By way of example and not limitation, the glass nesting fixture 20 can include a 2 inch diameter tube frame construction with leveling. Vacuum cups and control circuitry can be provided for holding the workpiece in place within the nesting fixture 20. Bumpers with threaded rod adjustment can also be provided for location of the workpiece with respect to the nesting fixture 20. Part present limit switches can be provided to signal the presence of a workpiece within the nesting fixture 20. Locators can also be provided for shifting the workpiece into a predetermined location with respect to the nesting fixture in response to actuation of the part present limit switches. At least one robot or other automated material application equipment 22 is provided for operative interaction with the workpiece 12 mounted within the nesting fixture 20 at the workstation 10. The robot or other material application equipment is in fluid communication with material dispense equipment 24 for supplying the material to be applied to a surface of the workpiece 12 held in the nesting fixture 20. One or more ventilation ducts 26 can be provided for ventilating the area of the workstation 10. A control panel 28 can be provided for controlling the robot or other material application equipment 22 in order to apply the appropriate material in the desired application sequence, and along a programmable path based on an identification of the pattern, size, and/or shape of the workpiece to be processed. The control panel 28 can include an emergency stop button 30. A workstation control panel 32 can be provided for controlling the operation of the nesting fixture 20 and/or for controlling the operation of the load assist fixture 14. The workstation control panel 32 can include an emergency stop button 34. A safety run bar or switch 36 can be provided for dual handed operation by the loading and unloading operator to cycle the fixturing of the next workpiece to be processed and cycling the operation of the robot or material application equipment to dispense the appropriate selected material in the selected application sequence along a programmed path based on an identification of the pattern, size, and/or shape of the workpiece to be processed. A main input/output enclosure panel 38 can be provided for the workstation. The main panel can route power and/or control lines to and from the workstation 10 with appropriate switches, breakers, and diagnostic lights to simplify proper operation of the workstation 10. A supplemental enclosure panel 40 can also be provided if desired to interface power and/or control signals with the material dispense equipment 24 and to interact with the robot or material application equipment control panel 28.

In operation, a workstation operator uses the load assist fixture 14 to remove an unprimed workpiece from the storage rack 12 and moves the workpiece along the bridge and rails 16, 18 to a position to load the nesting fixture 20. After loading the unprimed workpiece in the nesting fixture 20, the operator activates the run bar or switch 36 to activate the holding, and/or clamping and/or locating components of the nesting fixture 20, and to activate an identification of the workpiece by pattern, size, and/or shape of the workpiece. An identification signal is sent to the control panel 28 for the robot or other material application equipment 22 where the appropriate material is selected, the appropriate application sequence is selected, and a programmed path based on the identification signal of the workpiece is selected for automatic application of the material along the programmed path for applying material to a surface of the workpiece to be processed. The pattern, size, and/or shape of the workpiece can be identified in a variety of ways. By way of example and not limitation, the workpiece can be identified by operator input, either directly through a keypad entry or through a bar code scanning, or can be identified with a computerized vision system. In the preferred configuration, an ultrasonic identification system can be used to identify the particular workpiece placed in the nesting fixture 20. The ultrasonic system can also be used to detect a residual pre-primer film on a surface of a workpiece positioned in the nesting fixture 20 of the workstation 10. If the pre-primer coating is detected as existing in the desired area of the surface of the workpiece, the robot or other material application equipment 22 is activated to apply a primer material layer over the residual film in preparation for subsequent application of a third material layer. By way of example and not limitation, the third material layer can include a urethane sealant material layer to be applied over the primer material layer applied by the robot or other material application equipment 22. If the residual pre-primer film is not detected on the surface of the workpiece, the robot can be prevented from applying the primer layer to the surface of the workpiece, and the control panel can signal a rejected workpiece. The robot or material application equipment 22 can be returned to a ready position allowing removal of the workpiece from the nesting fixture 20. The nesting fixture 20 can be de-energized to release any clamps or suction cup vacuum holding the workpiece in position within the nesting fixture 20. The load/unload assist fixture 14 can be manipulated along the bridge and rails 18 in order to operably engage the workpiece within the nesting fixture 20 in order to lift and move the workpiece from the nesting fixture 20 to a primed workpiece storage rack 12. The load/unload assist fixture 14 can include appropriate clamps and/or vacuum suction cups to operably engage and hold the workpiece during the transport procedure. After the primed workpiece has been transported along the rails and across the bridge to an appropriate storage rack 12 and properly positioned therein, the assist fixture 14 can be de-energized to release any clamps and/or vacuum suction cups to transfer the workpiece from the assist fixture 14 to the storage rack 12. The assist fixture 14 can then be moved along the rail to an unprimed workpiece storage rack 12 where a subsequent unprimed workpiece is operably engaged for transport to the nesting fixture 20. The entire process is then repeated for the unprimed workpiece. If a workpiece has been rejected for failing to include a pre-primer coating in the appropriate areas on the surface of the workpiece, the workpiece can be removed from the nesting fixture 20 with the assist fixture 14 for transportation to an appropriate rejected part storage rack 12.

By way of example and not limitation, suitable ultrasonic identification systems can be obtained from Quiss GmbH of Puchheim, Germany. The system can check the width, position, and completeness of the pre-primer coating on the surface of the workpiece, as well as the width, position, and completeness of the primer being applied continuously during the application process. The system can be equipped with extremely fast algorithms so that inspection can be conducted in real time at production speeds. The system can be directly connected to the robot controller, and the sensor can be used with all conventional fuel bus systems. The commercially available system allows target values and tolerance ranges to be quickly entered in the programming device and the operating status can be displayed directly on the robot controller. The image processing software can be integrated in the sensor, independent of the technology package installed on the robot controller to enable the sensor to be operated independently of the robot in use. The sensor can be easily integrated into any robot. The sensor can include a camera and lighting. The sensor can be mounted directly to a material application nozzle or other tool. The basic configuration can include a control cabinet and a visualization and control unit. Any number of cameras can be used depending on production conditions. The sensors and the components can be provided in a fixed position installation, or it can be provided in a mobile installation attached to the robot or other material application equipment for movement along the desired path of travel during application of the material to the surface of the workpiece. The result in parameter data can be displayed and edited at the workstation, or at a host computer, or at any authorized computer in a network.

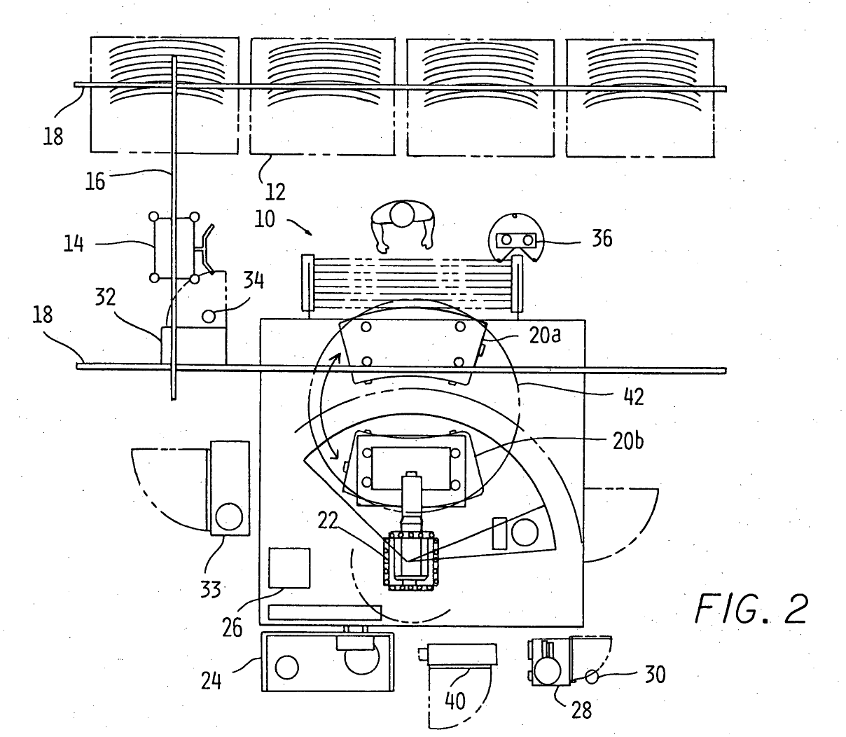

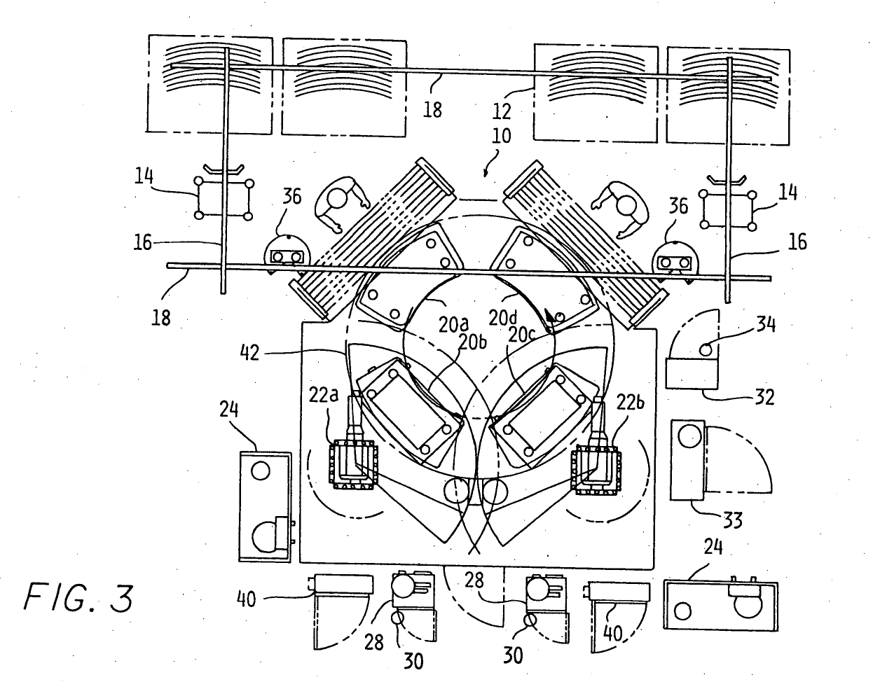

It has been estimated that a black prime application with heated glass can be applied in a workstation according to the configuration illustrated in FIG. 1 at a rate of 20 jobs per hour. If increased production is desired with red and black prime application, the configuration illustrated in FIG. 2 has been estimated to provide production at a rate of 65 jobs per hour. The configuration at operation of FIG. 2 is identical to that previously described with respect to FIG. 1 with the exception of the addition of a two station index table 42 having 180 degree oscillating or rotary movement about a rotational axis. The table top frame allows first and second nesting fixtures 20a, 20b to be attached to diametrically opposite ends of the table for oscillating movement between first and second positions corresponding to a loading/unloading position, and a processing position. This allows the workstation operator to unload a primed workpiece from one nesting fixture 20a or 20b while the robot or other material application equipment 22 applies material to the workpiece located at the processing position in the other nesting fixture 20b or 20a. During the time required for the robot to apply one or more layers of material to the workpiece at the processing location or position, the workstation operator can unload a finished piece from the other nesting fixture for transport to an appropriate coated workpiece storage rack 12, and load another uncoated workpiece from an appropriate uncoated workpiece storage rack 12 for delivery to the empty nesting fixture. After the uncoated workpiece has been loaded into the nesting fixture, and after the workpiece has been coated in the processing location, the turntable can oscillate to exchange the two workpieces between the loading/unloading position and the. processing position to repeat the sequence of steps for continued processing of workpieces. It should be recognized that the use of a turntable is considered to be the most efficient configuration as illustrated in the configurations of FIGS. 2 and 3. However, it should be recognized by those skilled in the art that parts can be delivered to the processing position in any variety of forms, including various types of workpiece conveyors other than turntables. In the preferred configuration, the ultrasonic identification system can pattern match hundreds of different styles of workpieces to be processed through the workstation. The different styles are capable of being held stable within a nesting fixture having appropriately positioned vacuum cups. The ultrasonic vision system can identify the pattern, size, and/or shape of the workpiece in order to select the appropriate material to be applied, sequence of application, and/or path of application of the material to be applied. The ultrasonic vision device can also be used to detect a residual film or coating to verify its presence in the appropriate locations prior to applying another material over the residual coating.

Referring now to FIG. 3, if even greater production rates are required, the illustrated configuration is estimated to provide a production rate of approximately 130 jobs per hour. The operation and configuration of the workstation illustrated in FIG. 3 is identical to that previously described for FIGS. 1 and 2 with the exception of a four station index table 44 is provided in place of the two station index table 42 illustrated in FIG. 2. The four station index table can be provided with continuous rotation to move a part loaded into a first nest at a loading station to a first processing station, where a first robot or other material application equipment 22a applies a first material layer to the workpiece along a desired path and in a desired sequence. While the workpiece in the first nest is being processed at the first processing station, a second nest is being loaded with a workpiece at the loading station. When the turntable rotates again, the workpiece in the first nest is delivered to a second processing station, while the workpiece in the second nest is delivered to the first processing station, and a third nest is positioned at the loading station for receiving another workpiece. The workpiece in the second nest is processed in the same manner as described for the workpiece in the first nest. The first nesting fixture now located at the second processing workstation is positioned within the work zone of a second robot or material application equipment 22b. The second robot or material application equipment 22b then applies a second material layer to the workpiece along the particular path and in the desired sequence for the particular workpiece as identified by the ultrasonic identification system. The ultrasonic identification system can determine whether the first material layer applied to the workpiece exists in the proper locations prior to application of the second material layer by the second robot or material application equipment 22b. If the first material layer is absent or does not exist in the appropriate locations within the parameters set, the workpiece can be rejected prior to application of the material by the second material application equipment or robot 22b. After completion of the processing at the first and second processing stations, and loading of a new part at the loading station into the third nesting fixture, the turntable can incrementally move the workpieces to the next workstation. In this position, the first nesting fixture and the workpiece located thereon is located at an unloading station where a workstation operator can remove the workpiece from the first nesting fixture for transport by the assist fixture along the rail and bridge to an appropriate workpiece storage rack 12. The workpiece located in the second nesting fixture has been moved from the first processing station to the second processing station for application of the second material layer. The workpiece located in the third nesting fixture has moved from the loading station to the first processing station for application for the first material layer by the first mater equipment or robot 22a. A fourth nesting fixture is now located at the loading station, where a workstation operator can remove an uncoated workpiece from an appropriate storage rack 12 for positioning using the assist fixture for movement along the rail and ridge to locate the workpiece in the fourth nesting fixture. While the configuration illustrated in FIG. 3 depicts a turntable configuration, it should be recognized by the those skilled in the art that workpieces can be moved between the four stations by any appropriate workpiece conveyor system known to those skilled in the art.

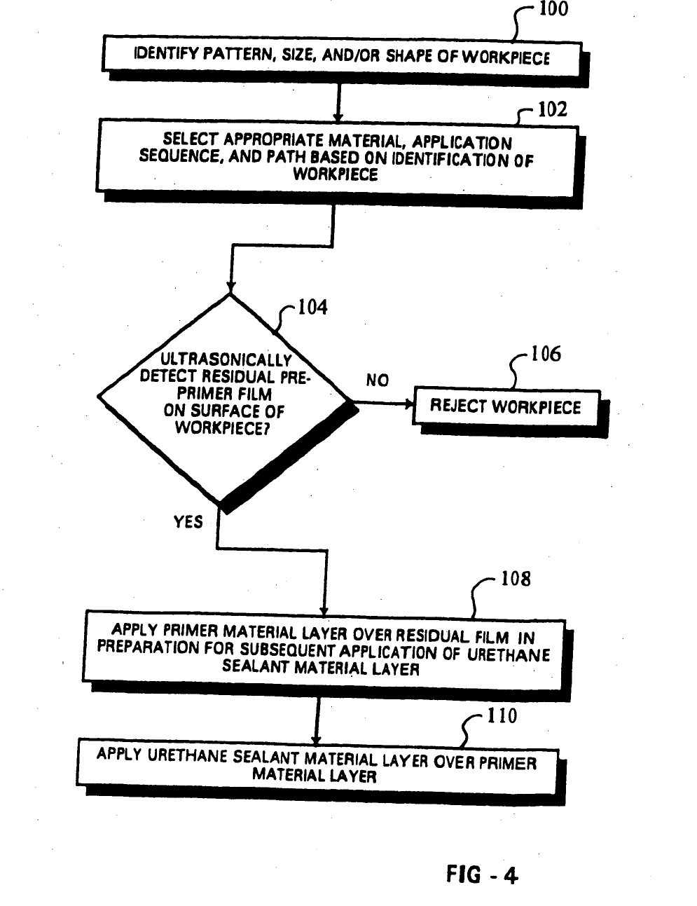

Referring now to FIG. 4, the present invention includes a process for applying a layer of material to a workpiece for a vehicle. The process can include the step 100 of identifying a pattern, a size, and/or a shape of a workpiece to be processed. The identification can be performed by any suitable process known to those skilled in the art, such as operator input, bar code scanning, vision system scanning, and/or ultrasonic scanning. In the preferred configuration, identification of the workpiece can be accomplished with ultrasonic verification of the pattern, size, and/or shape of a workpiece. Based on the identification of the workpiece, the process continues to step 102 where the appropriate material is selected for application to the particular identified workpiece, the application sequence of the material is selected based on the identification of the workpiece to be processed, and/or the path of the material application equipment or robot is selected based on the identification of the workpiece. After selection of the appropriate material, sequence, and/or path, the process continues to query 104 where it is determined ultrasonically whether a residual pre-primer film is detected on a surface of the workpiece to be processed. If the residual pre-primer film is not detected ultrasonically on a surface of the workpiece, the process branches to step 106 where the workpiece is rejected. If the residual pre-primer film is ultrasonically detected on a surface of the workpiece, the process continues to step 108 where the material application equipment or robot applies a primer material layer over the residual film in preparation for subsequent application of a urethane sealant material layer. The process can then continue to step 110 where the material application equipment or robot can apply a urethane sealant material layer over the primer material layer previously applied. In other words, the process according to the present invention can include the steps of ultrasonically verifying a residual film from a first material layer previously applied to a surface of a workpiece, and if verified, applying a second material layer over the first material layer on the surface of the workpiece. The process can also include applying the first material layer to at least a portion of the surface of the workpiece using the material application equipment or robot at a workstation, and drying the first material layer to form a clear transparent surface. The first material layer can be provided as a pre-primer material for application to a least a portion of the surface of a workpiece. The process according to the present invention can also include applying a third material layer over the second material layer previously applied to the surface of a workpiece. The third material layer can be provided as a urethane sealant material for application to at least a portion of the surface of the workpiece. The second material layer can be provided as a primer material application to at least a portion of the surface of the workpiece.

The workpiece according to the present invention can include a contoured glass member defining the workpiece to be processed. A pre-primer material can be applied to at least a portion of the contoured glass member. The first material layer can be dried to form a clear transparent surface. A primer material can be provided for application on top of the first material layer located on the surface of the workpiece. A urethane sealant material can also be provided for application on top of the primer material layer located on the surface of the workpiece.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A process for applying a layer of material to a workpiece for a vehicle comprising the steps of:
ultrasonically verifying a residual film from a first material layer previously applied to a surface of a workpiece; and
if verified, applying a second material layer over the first material layer on the surface of the workpiece.

2. The process of claim 1 further comprising the steps of:
applying the first material layer to at least a portion of the surface of the workpiece; and
drying the first material layer to form a clear transparent surface.

3. The process of claim 2, wherein the first material layer applying step further comprises the step of:
providing a pre-primer material for application to at least a portion of the surface of the workpiece.

4. The process of claim 1 further comprising the steps of:
applying a third material layer over the second material layer previously applied to the surface of the workpiece.

5. The process of claim 4, wherein the third material layer applying step further comprises the step of:
providing a urethane sealant material for application to at least a portion of the surface of the workpiece.

6. The process of claim 1, wherein the second material layer applying step further comprises the step of:
providing a primer material for application to at least a portion of the surface of the workpiece.

7. The process of claim 1 further comprising the steps of:
providing a contoured glass member as the workpiece to be processed;
providing a pre-primer material as the first material layer for application to at least a portion of the surface of the workpiece;
applying the first material layer to the surface of the workpiece;
drying the first material layer to form a clear transparent surface;
providing a primer material as the second material layer for application on top of the first material layer on the surface of the workpiece;
providing a urethane sealant material as a third material layer for application to at least a portion of the surface of the workpiece; and
applying the third material layer on top of the second material layer on the surface of the workpiece.

8. The process of claim 1 further comprising the step of:
if the first material layer is not verified in the ultrasonically verifying step, rejecting the workpiece as defective.

9. The process of claim 1 further comprising the step of:
identifying at least one of a pattern, size, and shape of a contoured glass workpiece to be processed; and
selecting at least one of material layers to be applied, a sequence of application, and a path of applicator travel based on the workpiece identified in the identifying step.

10. The process of claim 9, wherein the identifying step further comprising the step of:
ultrasonically identifying at least one of pattern, size, and shape of a contoured glass workpiece.

11. An apparatus for applying a material layer to a workpiece for a vehicle comprising:
means for ultrasonically verifying a residual film from a first material layer previously applied to a surface of a workpiece; and
if verified, means for applying a second material layer over the first material layer on the surface of the workpiece.

12. The apparatus of claim 11 further comprising:
means for applying the first material layer to at least a portion of the surface of the workpiece; and
means for drying the first material layer to form a clear transparent surface.

13. The apparatus of claim 12, wherein the first material layer applying means further comprises:
means for providing a pre-primer material for application to at least a portion of the surface of the workpiece.

14. The apparatus of claim 11 further comprising:
means for applying a third material layer over the second material layer previously applied to the surface of the workpiece.

15. The apparatus of claim 14, wherein the third material layer applying means further comprises:
means for providing a urethane sealant material for application to at least a portion of the surface of the workpiece.

16. The apparatus of claim 11, wherein the second material layer applying means further comprises:
means for providing a primer material for application to at least a portion of the surface of the workpiece.

17. The apparatus of claim 11 further comprising:
means for providing a contoured glass member as the workpiece to be processed;
means for providing a pre-primer material as the first material layer for application to at least a portion of the surface of the workpiece;
means for applying the first material layer to the surface of the workpiece;
means for drying the first material layer to form a clear transparent surface;
means for providing a primer material as the second material layer for application on top of the first material layer on the surface of the workpiece;
means for providing a urethane sealant material as a third material layer for application to at least a portion of the surface of the workpiece; and
means for applying the third material layer on top of the second material layer on the surface of the workpiece.

18. The apparatus of claim 11 further comprising:
means for rejecting the workpiece as defective, if the first material layer is not verified in the ultrasonic verifying means.

19. The apparatus of claim 11 further comprising:
means for identifying at least one of a pattern, size, and shape of a contoured glass workpiece to be processed; and
means for selecting material layers to be applied, a sequence of application, and a path of applicator travel based on the workpiece identified in the identifying means.

20. An apparatus for applying a material layer to a workpiece for a vehicle comprising:
a contoured glass workpiece having a pre-primer material layer applied along a predetermined path on a surface of the workpiece leaving a residual film;
an ultrasonic sensor for identifying a workpiece and for verifying presence of the residual film of pre-primer material layer along the predetermined path on the surface of the workpiece;
a first applicator for applying a primer material layer over the pre-primer material layer on the surface of the workpiece, if presence of the residual film is verified; and
a second applicator for applying a urethane sealant material layer over the primer material layer on the surface of the workpiece.
